(19) United States
(12) Patent Application Publication
(10) Pub. No.: US 2011/0137680 A1
(43) Pub. Date: Jun. 9, 2011

(54) HOSPITAL ADMINISTRATION SYSTEM AND METHOD

(75) Inventor: JAMES M. SWEENEY, San Diego, CA (US)

(73) Assignee: PatientSafe Solutions, Inc., San Diego, CA (US)

(21) Appl. No.: 12/957,164

(22) Filed: Nov. 30, 2010

Related U.S. Application Data
(60) Provisional application No. 61/265,642, filed on Dec. 1, 2009.

(51) Int. Cl. G06Q 50/00; G06Q 10/00

(52) U.S. Cl. 705/3; 705/2; 235/380

(57) ABSTRACT

A hospital administration system is described that includes a handheld device that communicates with a central server and a patient portal device. The patient portal is configured to run software that checks for potential medical errors that may affect a patient, and then warn the patient of the potential error.

### RELATED APPLICATIONS

This Application claims priority to and the benefit of U.S. Provisional Application No. 61/265,642 entitled HOSPITAL ADMINISTRATION SYSTEM AND METHOD, filed on Dec. 1, 2009, the entire contents of which are incorporated herein by reference.

### BACKGROUND OF THE INVENTION

1. Field of the Invention

The invention relates generally to systems for managing patient care in a health care facility, and more particularly, to integrated systems providing patient-centric care in hospitals.

2. Background

Medical institutions are constantly looking for ways to improve patient care and efficiency. Medical errors, such as: medication errors (including wrong medicine, wrong dose, or allergic reactions), patient falls, laboratory and phlebotomy collection errors, breast-milk matching errors, blood transfusion errors, wrong surgical patients, wrong surgical treatments, wrong site surgeries, retainment of foreign objects, wrong gas administrations, wrong infant discharge, missing patients, and others are all problems hospitals have sought to remedy with advanced systems. These medical errors do not only affect the patient, but they affect the efficiency, liability and profitability of an institution and its staff; thus, they are a high priority to address.

Various solutions to these problems have been proposed, such as systems that use bar codes to identify patients and medications, or systems allowing the bedside entry of patient data. However, previous systems have tended to be only partially integrated, and have nearly always been designed around care-givers. What has been missing in this space is a fully integrated system designed from the ground up to be patient-centric and to provide the patient with a cone of protection that prevents medical harm to the patient during a hospital stay.

### SUMMARY OF THE INVENTION

Briefly and in general terms, the present invention provides a new and improved patient-centric care management system capable of monitoring and controlling the administration of care in a health care institution.

One embodiment includes a patient identifier configured to be worn by a patient and comprising an identification code that uniquely identifies the patient; a handheld device configured to read the identification code from the patient identifier; and a patient portal device, comprising a display and in communication with the patient identifier and the handheld device.

Another embodiment is an electronic system for displaying patient data to a patient in a hospital, comprising a server comprising a storage that stores patient records and a first module configured to provide a schedule of patient activities; a patient portal device configured to communicate with the server and display the schedule of patient activities to the patient; and a scheduling module running on the patient portal device and configured to update the schedule of patient activities.

Yet another embodiment is a system for protecting a patient from medical errors, comprising a server configured to store patient medical records; a patient portal device in communication with the server and configured to electronically monitor the patient medical records for indicators of medical errors; and a protection module configured to generate a patient-specific alert on the patient portal device if an indicator of a medical error is discovered.

### BRIEF DESCRIPTION OF THE DRAWINGS

FIG. 1 is a graphic representation of a patient-centric care management system incorporating principles of the present invention and illustrating details of the hardware elements and data flows between the networked elements;

FIG. 2 is a graphic representation of a patient portal device of the patient-centric care management system of FIG. 1 showing various application module icons;

FIG. 3 is a graphic representation of a patient portal device of the patient-centric care management system of FIG. 1 showing a patient-centric interface screen;

FIG. 4 is a graphic representation of a wireless handheld device of the patient-centric care management system of FIG. 1 showing various application module icons;

FIG. 5 is a functional data flow diagram of the application server of the patient-centric care management system of FIG. 1;

FIG. 6 is a flowchart showing one method for treating a patient using the patient-centric care management system;

FIG. 7 is a flowchart showing one method for protecting a patient using a protection module within an application server; and

FIG. 8 is a flowchart showing one method for disassociating and associating patient portal devices with a patient who is moved between different rooms in a hospital.

### DETAILED DESCRIPTION

### Overview

One embodiment relates to a patient-centric care management system that is designed from the ground up to provide a cone of protection for a patient undergoing treatment in a hospital.

A first part of the patient-centric care management system in this embodiment is a wireless handheld device configured for use by medical staff, such as nurses and doctors. In practice the handheld device can be used to confirm medication orders prior to administration and to remind medical staff of patient appointments and medicine administration times. The wireless handheld device can also be used to provide caregivers with checklists, such as infection-prevention procedures for catheterization, appropriate time and technique for contrast agent administration for x-rays, or more generally hand-washing procedures before patient interaction.

In some embodiments, the wireless handheld device includes instructions for dealing with patient-specific conditions. For example, a patient being treated with anticoagulants (blood thinners) is scheduled for a blood draw. Upon entering the room, the phlebotomist uses the handheld device to scan the patient's wristband. The handheld device then receives a unique patient identification number that provides access to patient-specific data such as the current anticoagulant therapy, which is stored on a server. When the phlebotomist enters the scheduled treatment on the handheld device, the handheld device and the patient portal immediately display or make audible warnings regarding the patient's current anticoagulant treatment. Thereafter, the handheld device displays procedures for drawing blood from an anti-coagulated patient in checklist form. Another example is a patient scheduled for physical therapy who is being treated with powerful pain medications. Upon entering the room, an attendant who plans to move the patient scans the patient's wristband and receives patient specific data. When the attendant enters the planned move into the handheld device, it immediately displays or makes audible a warning indicating a fall risk for the patient. Thereafter, the attendant is able to either take extra precaution in moving the patient, or inquire regarding a schedule change so the patient can be moved at a safer time.

In other embodiments, the wireless handheld device includes instructions for nurses and doctors prior to a surgical procedure. For example, when a patient is moved into a surgery room, a nurse may scan the patient's wristband with a handheld device. When treatment information is entered into the handheld device regarding the surgery, the handheld will confirm that it is the correct patient for the surgery (or alternatively warn if it is not the correct patient), and provide a checklist for confirming surgical procedure and surgical site. At this time the handheld can also require confirmation of other patient-protecting activities such as hand washing, sterilization of instruments, and other such procedures. Patient-specific information such as age, weight and other metrics can be displayed on an anesthesiologist's wireless handheld device to help tailor correct anesthesia regimens. Further, as the handheld device is wirelessly linked to other elements of the patient-centric care management system, the handheld may also then provide access to medical records such as x-rays, MRI scans, and others which are useful for surgery preparation.

In one embodiment the handheld device interacts with other hospital equipment. For example, a nurse's handheld may indicate that an intravenous antibiotic treatment needs to be administered to a patient via a programmable, multi-channel infusion pump. The nurse then enters the patient's room, scans the patient's wristband, and scans the antibiotic drug container. After this, the handheld prompts the nurse to select an IV channel for infusion. When the nurse scans an IV channel that is already running, so that the treatment can be “piggybacked” on that channel, the handheld device displays an alarm indicating that the antibiotic drug is incompatible with the IV solution running on that channel, and instructs the nurse to select a separate channel. When the nurse scans an alternate channel, the handheld device then sends the programming information for the antibiotic infusion directly to the pump. The patient's portal is also updated to reflect the current treatment. If at any time during the treatment the pump encounters an error (such as a low battery indication), the pump can alert the handheld device and the portal device so that the problem is resolved promptly.

A second part of the patient-centric care management system in this embodiment is a “smart” patient wristband that can be worn by the patient and which links the patient elements of the patient-centric care management system by wireless communication. The wristband can communicate patient information to the handheld device, such as a unique patient identifier, or other patient specific information, such as drug allergies or special instructions. In some embodiments the wristband is disposable, while in others the wristband is reusable.

A third part of the medical management system in this embodiment is a patient portal device that is configured for use by the patient and the medical staff. The patient portal may be a touch-screen configured computer system, or other related computing device. The patient portal may be configured to provide the patient with a means for protection against medical errors while the patient is in the hospital. For example, the patient portal may be configured to communicate wirelessly with the patient wristband so that once the patient comes within a predefined proximity to the patient portal, the patient portal awakes and begins to monitor all the interactions between the hospital and that patient. For example, when a nurse enters the patient's room, the patient portal may be configured to read the Real-Time Location and Identification Services (RTLS) tag of the nurse and announce the name and position of that nurse to the patient. This prevents unauthorized individuals from entering the patient's room and pretending to be part of the hospital staff. Similarly, other hospital workers such as doctors, phlebotomists, x-ray technicians, etc. could similarly be identified by the patient portal and announced so that the patient is confident that the person entering their room is authorized. In one embodiment, a stored photograph of the person entering the room is displayed on the portal, along with the person's name, identification number and position at the hospital. In other embodiments, the portal may display information for multiple caregivers in a room at the same time. In yet other embodiments, the portal keeps a record of all of the hospital personnel that have been in a patient's room.

One embodiment includes digital entrance questionnaires on the patient portal. These questionnaires can ask about the patient's overall health, including habit information such as whether the patient is a smoker or has a history of high blood pressure, or ask about past surgeries the patient has had, or ask about current medications taken at home, including both prescription and non-prescription (over the counter) medications. For example, a questionnaire screen on the patient portal may ask the patient if they currently take any pain medications, or insulin for diabetes, or medications for arthritis, and so on. This embodiment can be further enhanced with pictures that assist the patient in identifying drugs taken at home. The answers to the questionnaires may then be stored in the patient's records such that every caregiver that interacts with the patient is aware of these medications and their possible interaction with any hospital acquired treatments. In some embodiments, the patient portal includes exit questionnaires so that the patient may answer questions regarding quality of treatment, satisfaction, and other criteria before leaving the hospital, which may subsequently be used to improve the care given at the hospital.

In other embodiments, the patient portal includes a reference application which allows the patient to look up information about treatments, diagnoses, medications, safe practices, care protocols and other information that the patient may desire to better understand their conditions and treatments. Such information may be provided through locally hosted information sources, such as databases, or may be provided by access to internet-based services (e.g. WebMD.com). For example, a patient may be prescribed a drug for which she wishes to know possible side-effects. Before taking the drug, the patient could access a reference application on the patient portal to retrieve information on the drug, which she can then discuss with medical staff if she perceives a problem.

In some embodiments, the patient portal may show informative videos, including videos that provide information and educate the patient about upcoming treatments, surgeries, or other procedures within the hospital that the patient wishes to learn about or has been instructed by a nurse or doctor to learn about; videos that address recovery regimens and outpatient care topics; or any other type of video that is patient-oriented. For example, the patient may be admitted for surgery the next day. Upon arriving in her room, the patient is directed by a nurse to use the portal to access videos about a particular preparation regimen for that patient's surgery (such as no eating after midnight); videos that describe the surgery itself; and post-surgery recovery guidelines. These videos may be stored locally on the patient's portal or stored remotely and accessible over a network.

Other embodiments of the patient portal include applications that allow a patient to access his medical records and other patient-specific information stored on or available to hospital systems. For example, a patient may wish to access lab results or digitized x-ray or MRI results in an effort to have more informed discussions with a doctor regarding his progress. In yet other embodiments, the portal allows the patient to share these results with outside sources, such as other doctors not affiliated with the hospital in which the patient is receiving treatment, or with family. For example, the patient may wish to obtain a second opinion on MRI results while in a hospital receiving treatment. The patient is able to access his results from his portal, and share them with an external specialist directly.

In one embodiment, the patient portal records video that can be stored and played back later by the patient. For example, a doctor may wish to discuss the outcome of a surgery with the patient and the patient's family. The discussion may be recorded by the patient portal such that the patient can review the discussion after waking up, or coming off of the effects of heavy medication. Further, the patient's family may view the video later on the same portal while visiting the patient. In this way, the doctor need not give the same explanation twice, and the patient and the patient's family may access the explanation whenever it is most convenient.

In another embodiment, the patient portal runs instructions that automatically monitor for any interaction between a nurse or doctor and the patient. For example, as the nurse scans a prescribed medicine using a handheld device, the patient portal monitors the medicine and then checks to determine that the medicine will not have an adverse impact on the patient. In one embodiment, the patient portal is linked to a patient record that stores allergy and other information on the patient. The portal can automatically check the patient record to ensure that the patient is not allergic to the medicine being administered by the nurse. In addition, the system can check to determine that the medicine being administered will not interact with prior medicines. For example, in some circumstances the nurse may not be aware that another nurse already administered the medicine, or that another nurse or doctor may have administered a medicine that might adversely interact with the medicine that the nurse is about to administer. Under these circumstances, the patient portal would provide an alert to the patient indicating that the medicine should not be administered. In this manner the portal is configured to protect the patient from any inadvertent medical errors that may be committed by the hospital staff.

One embodiment includes patient alerts that are proper for a patient and not the hospital staff. For example, in prior systems, the alerts would be designed to be displayed to the hospital staff and not to the patient. In contrast, in some embodiments, the alert is designed to be directly displayed or otherwise indicated to the patient, using language that makes it easy for the patient to understand. For example, the patient portal may flash with large red letters stating “WARNING, THE NURSE IS ATTEMPTING TO ADMINISTER PENICILLIIN. YOUR PATIENT RECORD INDICATES THAT YOU ARE ALLERGIC TO PENICILLIIN. NOTIFY THE NURSE OF YOUR ALLERGY TO PENICILLIIN IMMEDIATELY.” Alternatively, the portal may render an audible warning where the same is said electronically through a speaker on the patient portal. In contrast to prior systems, in this embodiment, the alert is designed to be viewed and acted upon by the patient, and not the hospital's medical staff.

In other embodiments, the patient portal includes patient status screens. For example, a recovering patient may use his portal to indicate that his pain level is increasing. This indication will, in-turn, notify a nurse or doctor that the patient needs care. When a nurse or doctor comes to administer a pain treatment, the portal will provide the patient with feedback on the suggested treatment and warn of any allergies or adverse interactions with other current treatments. Additionally, the portal will indicate to the patient his schedule of upcoming and past treatments to that he may manage his treatment requests accordingly.

In another embodiment, the patient portal may be configured to prevent a doctor from performing a procedure that is unadvisable in view of an earlier procedure, or earlier medicine administration. For example, a patient may have been given a blood thinner as part of his treatment. However, a later procedure may not be advisable or may require additional procedures if the patient had taken a blood thinner. Accordingly, the patient portal monitors for these and other such procedures that may be contraindicated based on prior medicine administration. If an unadvisable procedure is detected by the patient portal, it can alert the patient by visual (e.g. text-based) and audible (e.g. computer generated voice) warnings. The portal may monitor for such procedures by having a nurse or doctor input the designated procedure into the handheld device or patient portal. In another embodiment, the patient may enter the procedure into the patient portal directly. In yet other embodiments, the patient portal may display checklists and other procedural treatment information to the patient when a doctor or nurse or other staff member begins to administer a patient treatment. In this way, the patient is able to better monitor his own care and prevent mistakes.

In some embodiments, the patient portal provides a range of services that are beneficial to the patient as they stay in a hospital. For example, in one embodiment, the patient portal may maintain a daily schedule of all the patient's activities. These activities may include a schedule of what medicines are to be administered and what the patient's dietary guidelines are for the day (e.g. no caffeine). The schedule may include the scheduled times of x-ray tests, or physical therapy treatments. A schedule of the expected rounds by the attending doctor may also be included. The schedule can also contain the patient's treatment goals for a set period of time, such as the day, the week, or during the stay. An example may include a goal for the patient to complete certain exercises to improve range of motion in a joint where surgery was previously performed, or walking a certain distance to aid in other forms of recovery. Because the schedule is designed for the patient, the portal can be configured so that other patient-centric information may also be inputted and displayed, such as family visits or other personal calendar appointments. These can be input from the patient portal using, for example, a keyboard or touch-screen system.

In another embodiment, the patient portal may be used by the patient to communicate with caregivers and systems internal to the hospital. For example, the portal may be configured to allow the patient to communicate directly by voice, text and video messaging with hospital staff including doctors, nurses, and other staff. In some embodiments, the patient portal has a phone directory application that facilitates the patient's communication with hospital staff. In one embodiment, the patient portal is used to send a text or voice message directly to a handheld device used by the hospital staff.

In other embodiments, the portal may include an application that allows the patient to select meal options and times, instead of relying upon a nurse or dietician to take the meal orders. The system can automatically check the ordered meal against the patient's record to ensure compliance with any dietary restrictions in place. For example, if a patient is not supposed to have caffeine, the system would not allow the patient to order coffee with breakfast, and would instead warn the patient that caffeinated beverages have are not allowed due to dietary restrictions.

The patient portal may also be configured to communicate outside of the hospital, for example by voice-based communication, such as voice-over-IP, or by text-based communication, such as email, text messaging, or multimedia messaging. This allows a patient to communicate with friends and family while there are at the hospital.

### Never Events

One embodiment is a patient-centric care management system that increases the quality and efficiency of care, while reducing costs and liability of an institution and its staff. Thus, in one embodiment, the system is configured to prevent “never events.” The National Quality Forum (NQF) has created a list of 27 Serious Reportable Adverse Events, or “never events,” which are defined as errors in medical care that are clearly identifiable, preventable and serious in their consequences for patients. The 27 NQF “never events” are shown in Table 1.

TABLE 1
NQF Never Events

Surgical Never Events
Surgery performed on the wrong body part
Surgery performed on the wrong patient
Wrong surgical procedure on a patient
Retention of a foreign object in a patient after surgery or other procedure
Intraoperative or immediately post-operative death in a normal healthy patient
Product or Device Never Events
Patient death or serious disability associated with the use of contaminated drugs,
devices, or biologics provided by the healthcare facility
Patient death or serious disability associated with the use or function of a device in
patient care in which the device is used or functions other than as intended
Patient death or serious disability associated with intravascular air embolism that
occurs while being cared for in a healthcare facility
Patient Protection Never Events
Infant discharged to the wrong person
Patient death or serious disability associated with patient disappearance for more
than four hours
Patient suicide, or attempted suicide resulting in serious disability, while being cared
for in a healthcare facility
Care Management Never Events
Patient death or serious disability associated with a medication error
Patient death or serious disability associated with a hemolytic reaction due to the
administration of ABO-incompatible blood or blood products (transfusion of the
wrong blood type)
Maternal death or serious disability associated with labor or delivery on a low-risk
pregnancy while being cared for in a healthcare facility
Patient death or serious disability associated with hypoglycemia, the onset of which
occurs while the patient is being cared for in a healthcare facility
Death or serious disability (kernicterus) associated with failure to identify and treat
jaundice in newborns
Stage 3 or 4 pressure ulcers acquired after admission to a healthcare facility
Patient death or serious disability due to spinal manipulative therapy
Environmental Never Events
Patient death or serious disability associated with an electric shock while being
cared for in a healthcare facility
Any incident in which a line designated for oxygen or other gas to be delivered to a
patient contains the wrong gas or is contaminated by toxic substances
Patient death or serious disability associated with a burn incurred from any source
while being cared for in a healthcare facility
Patient death associated with a fall while being cared for in a healthcare facility
Patient death or serious disability associated with the use of restraints or bedrails
while being cared for in a healthcare facility
Criminal Never Events
Any instance of care ordered by or provided by someone impersonating a physician,
nurse, pharmacist, or other licensed healthcare provider
Abduction of a patient of any age
Sexual assault on a patient within or on the grounds of a healthcare facility
Death or significant injury of a patient or staff member resulting from a physical
assault (i.e., battery) that occurs within or on the grounds of a healthcare facility

Beginning in October of 2008, as required by the Deficit Reduction Act of 2005, the Centers for Medicare & Medicaid Services (CMS) began identifying certain hospital-acquired conditions (HACs) that were determined to be reasonably preventable. These HACs are drawn from the NQF's list of “never events.” If a condition is not present upon admission, but is subsequently acquired during the hospital stay, the condition is a HAC and Medicare will no longer pay the additional cost of the hospitalization to treat the HAC. The cost of treating the HAC is not the patient's responsibility, but rather the hospital's. In this way, the hospital is being encouraged to prevent adverse events and improve the reliability of care it is giving to Medicare patients. The current HACs fall into 10 categories and include:

1. Foreign Object Retained After Surgery

2. Air Embolism

3. Blood Incompatibility

4. Stage III and IV Pressure Ulcers

5. Falls and Trauma
Fractures
Dislocations
Intracranial Injuries
Crushing Injuries
Burns
Electric Shock

6. Manifestations of Poor Glycemic Control
Diabetic Ketoacidosis
Nonketotic Hyperosmolar Coma
Hypoglycemic Coma
Secondary Diabetes with Ketoacidosis
Secondary Diabetes with Hyperosmolarity

7. Catheter-Associated Urinary Tract Infection (UTI)

8. Vascular Catheter-Associated Infection

9. Surgical Site Infection Following:
Coronary Artery Bypass Graft (CABG)—Mediastinitis
Bariatric Surgery
   Laparoscopic Gastric Bypass
   Gastroenterostomy
   Laparoscopic Gastric Restrictive Surgery
Orthopedic Procedures
   Spine
   Neck
   Shoulder
   Elbow
   Total Knee Replacement
   Hip Replacement

10. Deep Vein Thrombosis (DVT)/Pulmonary Embolism (PE)

Thus, one embodiment is a system that monitors for, and works to prevent, these “never events”. For example, some never events relate to serious patient pressure ulcers, which result from not being moved to different positions in the bed during an extended period of time. To prevent such ulcers, the patient portal can be configured to ask the patient if he has been moved during the past two hours, and if not, to then send a warning to a nurse or other caregiver's handheld to advise the nurse that the patient needs to be moved to prevent a pressure ulcer. Likewise, the handheld device can be programmed to indicate to a caregiver that a patient needs to be turned at a set interval of time. Accordingly, the patient portal provides an interactive interface that monitors and questions the patient about the care that the patient is receiving at the hospital, and through the systems and methods described below, ensures that the patient is being properly cared for to prevent medical errors during a hospital stay.

### DEFINITIONS

As used herein, an input device can be, for example, a keyboard, rollerball, mouse, voice recognition system or other device capable of transmitting information from a user to a computer. The input device can also be a touchscreen associated with the display, in which case the user responds to prompts on the display by touching the screen. The user may enter textual information through the input device such as the keyboard or the touchscreen.

A touchscreen is a display that can detect the presence and location of a touch within the display area. The term generally refers to touch or contact to the display of the device by a finger or hand. Touchscreens can also sense other passive objects, such as a stylus. The touchscreen has two main attributes: first, it enables one to interact with what is displayed directly on the screen, where it is displayed, rather than indirectly with a mouse or touchpad; secondly, it lets one do so without requiring any intermediate device, again, such as a stylus that needs to be held in the hand. Such displays can be attached to computers or, as terminals, to networks. Different technologies can be used to determine the location of a touch. Two common technologies are “resistive” touchscreens and “capacitive” touchscreens.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

As used herein, media refers to images, sounds, video or any other multimedia type data that is entered into the system.

A microprocessor may be any conventional general purpose single- or multi-chip microprocessor such as a Pentium® processor, a Pentium® Pro processor, a 8051 processor, a MIPS® processor, a Power PC® processor, an ALPHA® processor, ARM, Atom®, Core Duo®, or Core2Duo®. In addition, the microprocessor may be any conventional special purpose microprocessor such as a digital signal processor or a graphics processor. The microprocessor typically has conventional address lines, conventional data lines, and one or more conventional control lines.

The system is comprised of various modules as discussed in detail below. As can be appreciated by one of ordinary skill in the art, each of the modules comprises various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as OS X, LINUX, UNIX or MICROSOFT WINDOWS®.

The system may be written in any conventional programming language such as C, C++, BASIC, Pascal, or Java, and run within a conventional operating system. C, C++, BASIC, Pascal, Java, and FORTRAN are industry standard programming languages for which many commercial compilers can be used to create executable code.

A web browser comprising a web browser user interface may be used to display information (such as textual and graphical information) to a user. The web browser may comprise any type of visual display capable of displaying received information. Examples of web browsers include Microsoft's Internet Explorer browser, Apple's Safari browser, Netscape's Navigator browser, Mozilla's Firefox browser, or any other browsing or other application software capable of communicating with a network.

Embodiments disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

A Local Area Network (LAN) or Wide Area Network (WAN) may be an institutional computing network, including access to the Internet, to which computers and computing devices are connected. LANs and WANs are implemented with wired technologies such as IEEE 802.3 “Ethernet,” fiber-optic and others. In one embodiment, the LAN conforms to the Transmission Control Protocol/Internet Protocol (TCP/IP) industry standard.

Wireless network refers to any type of computer network that is wireless, and is commonly associated with a telecommunications network whose interconnections between nodes is implemented without the use of wires. Wireless Local Area Networks (WLANs) provide a Local Area Network (LAN) using radio instead of wires over a small area such as a home, office, or school. Most WLANs are based on the IEEE 802.11 standards. Specifically, such networking technology may include wireless technologies such as IEEE 802.11a/b/g/n “WiFi™,” IEEE 802.16 “WiMax™,” IEEE 802.14 “Ultra-Wideband™,” and IEEE 802.15 “Bluetooth™.”

Both wired and wireless networks can use network security protocols. A network security protocol can include security protocols: WEP (40 or 128 bit), TKIP, AES, WPA (Personal or Enterprise), WPA2 (Personal or Enterprise), 802.1x, EAP-TLS, TTLS (CHAP, MS-CHAP, MS-CHAPv2, PAP or MD5), PEAP (TLS, MS-CHAPv2, EAP-GTC), LEAP, EAP-FAST (TLS, MS-CHAPv2, EAP-GTC) and others.

A Real-Time Location and Identification Services (RTLS) system refers to a system comprising an integrated circuit for processing sound waves, optical data or storing and processing information, modulating and demodulating a radio-frequency (RF) signal, and other specialized functions, and an antenna for receiving and transmitting the RF signal. Several types of RTLS systems are known in the art including: active radio frequency identification (RFID) tags, which contain a battery and can transmit signals autonomously, passive RFID tags, which have no battery and require an external source to provoke signal transmission, battery assisted passive (BAP) devices, which require an external source to wake up but have great read range, sonic location technology and optical technologies.

### Overview of System

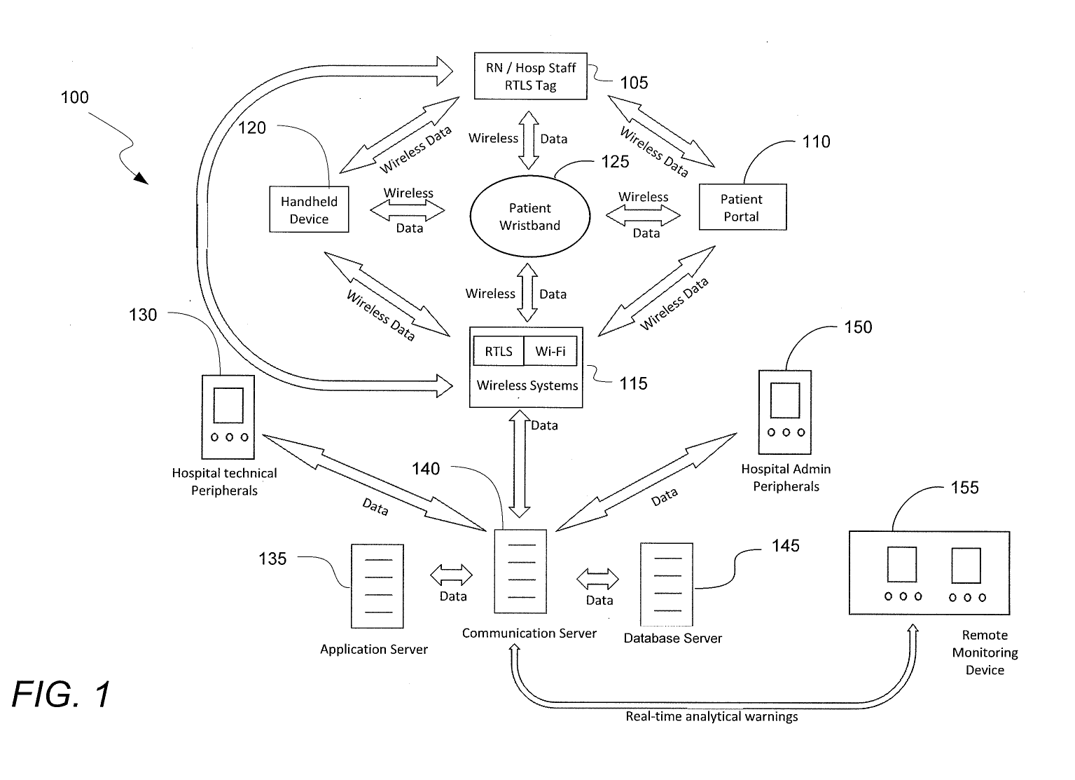

Referring now to the drawings, and specifically to FIG. 1, there is shown one embodiment of a patient-centric care management system 100. The patient-centric care management system shown in FIG. 1 is depicted as including a hospital identification tag 105, a patient portal device 110, a handheld device 120, a patient wristband 125, a wireless systems device 115, and a communication server 140, to which are connected an application server 135, database server 145, hospital technical peripherals 130, (such as, e.g., a smart IV infusion pump), hospital administrative peripherals 150 (such as, e.g., a pharmacy computer), and a remote monitoring device 155.

### Identification Tag

The identification tag 105 shown in FIG. 1 comprises a standard identification tag with an integrated RTLS tag for electronically identifying the wearer of the identification tag 105 to the patient-centric care management system 100. The integrated RTLS tag is responsive to information from the RTLS sensing system 115 located in each patient room or treatment area, which automatically provides the patient-centric care management system 100 with the identity of, and possibly other selected information about, the hospital staff. Such a system may be described as a passive recognition system in that the wearer need not take any active steps to inform the patient-centric care management system 100 of his location within the institution, or to inform the patient of his identity. The identification tag 105 may be worn attached to the clothes, to a necklace or bracelet, or other ways those skilled in the art would appreciate. In this way, the identification tag 105 not only serves to visually identify hospital staff, but also serves to electronically identify the staff as they move about the hospital and interact with patients.

RTLS can involve a variety of technologies for location and identification services. For example, RFID is one means that may be used for the identification tag 125 to automatically identify staff. This type and others are contemplated to work within the hospital identification tag 105 and with the wireless system 115.

### Patient Portal

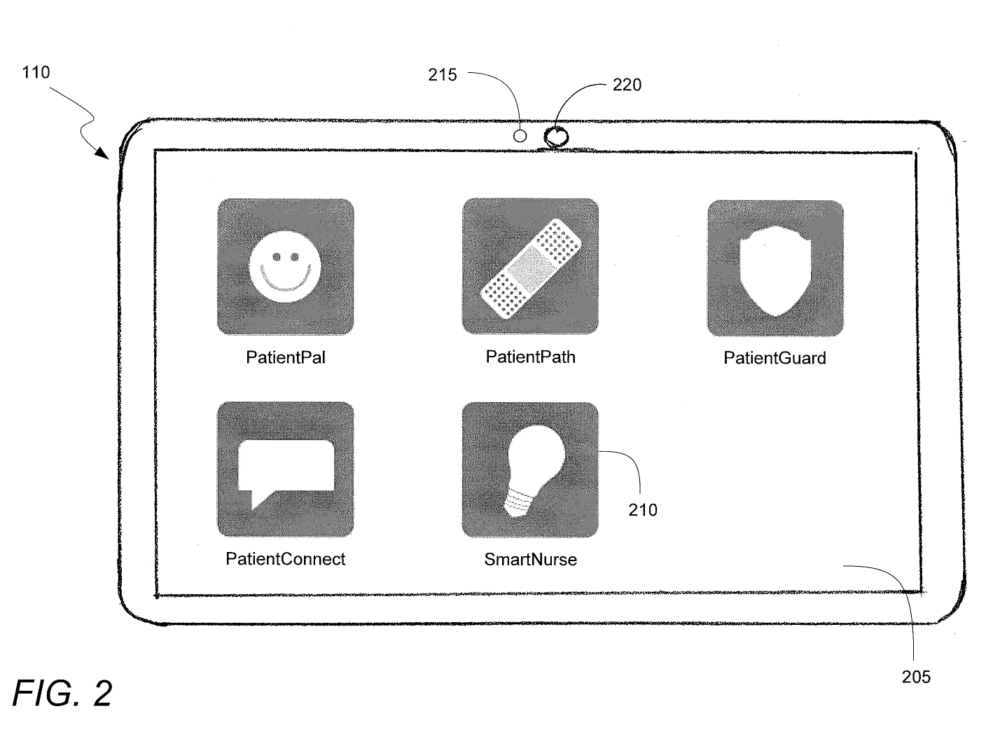

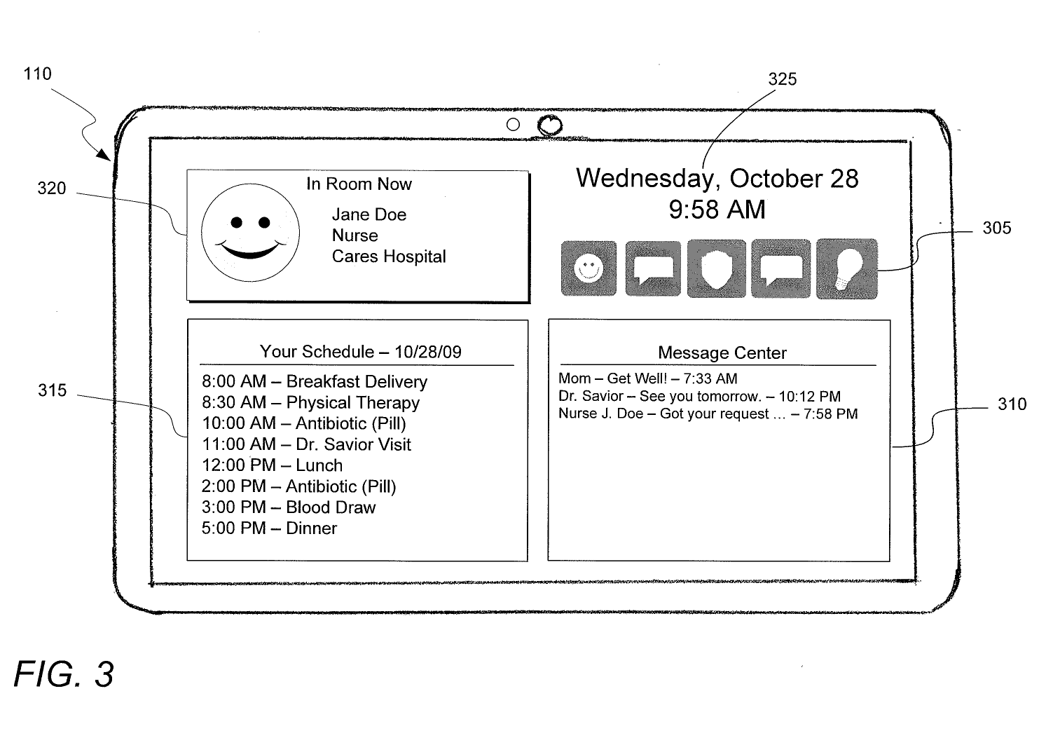

The patient portal device 110 comprises a portable computer designed to run applications or “modules;” capture data input by users, which is then shared with the various elements of the patient-centric care management system 100; and receive data from the various elements of the patient-centric care management system 100. In this embodiment, the patient portal device 110 has a touch-screen display interface and two-way communication capability. The patient portal device 110 is in data communication with the hospital identification tag 105, the patient wristband 125 and the wireless system 115, which provides connectivity with the patient-centric care management system 100. The patient portal device 110 may connect to the patient-centric care management system 100 via wired or wireless networking technology. Further aspects of the patient portal device 110 will be described below with reference to FIGS. 2 and 3.

### Handheld Device

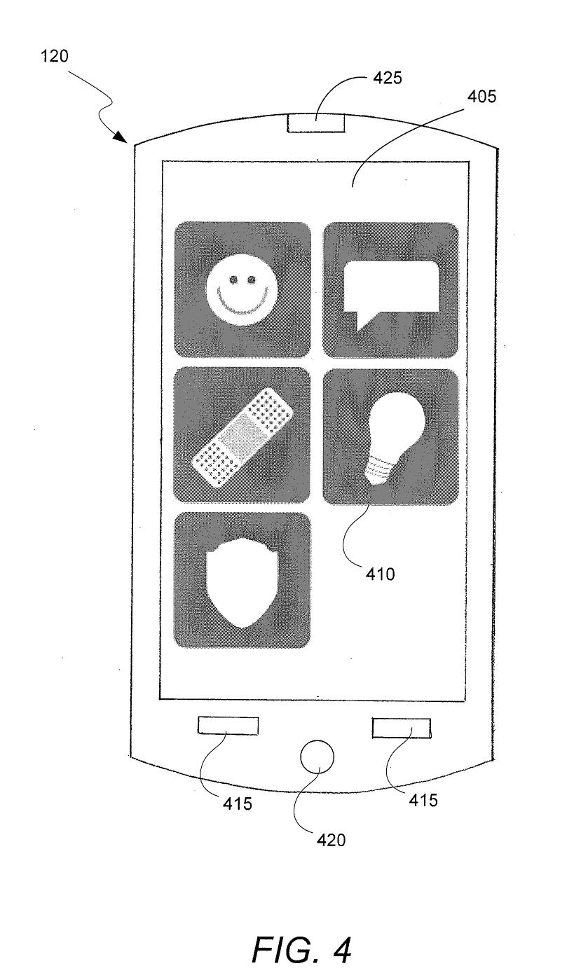

The handheld device 120 comprises a portable computer designed to run applications or “modules;” capture data input by users, which is then shared with the various elements of the patient-centric care management system 100; and receive data from the various elements of the patient-centric care management system 100. In this embodiment, the handheld device 120 has a touch-screen display interface as well as physical buttons and two-way communication capability. The handheld device 120 is in data communication with the hospital identification tag 105, the patient wristband 125 and the wireless system 115, which provides connectivity with other elements of the patient-centric care management system 100. Further aspects of the handheld device 120 will be described below with reference to FIG. 4.

### Patient Wristband

The patient wristband 125 comprises a wristband on which is stored a unique patient identification code and an integrated RTLS tag for wirelessly sharing the patient's identification code with the patient-centric care management system 100. The patient wristband 125 is in data communication with the hospital identification tag 105, the patient portal device 110, the handheld device 120 and the wireless system 115, which provides connectivity with other elements of the patient-centric care management system 100. The patient's unique identification code is stored on a memory device within the patient's wristband 125. The memory device may comprise read only memory (ROM), random access memory (RAM), flash memory, or other types of memory. In other embodiments, the patient's unique identification code may be stored on a removable memory media (such as a flash card, secure digital card, or others) which may be inserted into and removed from the patient wristband 125. Alternatively, the patient wristband 125 may have other wireless networking technologies integrated for data communications. In yet other embodiments, the patient wristband 125 may have a barcode or dotcode printed on it so as to be identified by optical scan.

### Wireless System

The wireless systems device 115 comprises transmitters, receivers, and antennas and other supporting hardware configured for a variety of wireless technologies to create data communications between elements of the patient-centric care management system 100. Additionally, the wireless systems device 115 comprises wired networking capability so as to connect with other wired elements of the patient-centric care management system 100 that do not include wireless networking technologies. It is contemplated that as technology advances, more and more equipment will be wireless enabled and thus more elements of the system presented herein will be wirelessly interconnected.

The wireless systems device 115 is in data communication with the hospital identification tag 105, the patient portal device 110, the handheld device 120 and patient wristband 125, and provides connectivity with other elements of the patient-centric care management system 100 via the communication server 140. The wireless systems device 115 may be integrated or may be multiple pieces of hardware which collectively establish wired and wireless communications between elements of the patient-centric care management system 100. The wireless systems device 115 may be located within a patient's room or in other locations such that wireless communications with other elements of the system is maintained. In the preferred embodiment, one or more of these systems will be installed so as to provide coverage to all patient areas throughout the hospital.

### Communication Server

The communication server 140 comprises a computer designed to process requests and deliver data to other elements of the patient-centric care management system 100 elements over a local area network (“LAN”) and to the Internet. The communication server 140 is in data communication with an application server 135, a database server 145, hospital technical peripherals 130, (such as, e.g., a smart IV infusion pump), hospital administrative peripherals 150 (such as, e.g., a pharmacy computer), a remote monitoring device 155, and a wireless system device 115, which provides connection to the hospital identification tag 105, the patient portal device 110, the handheld device 120, and the patient wristband 125. The communication server 140 can be a standalone device or integrated into other devices to provide the same functionality.

### Application Server

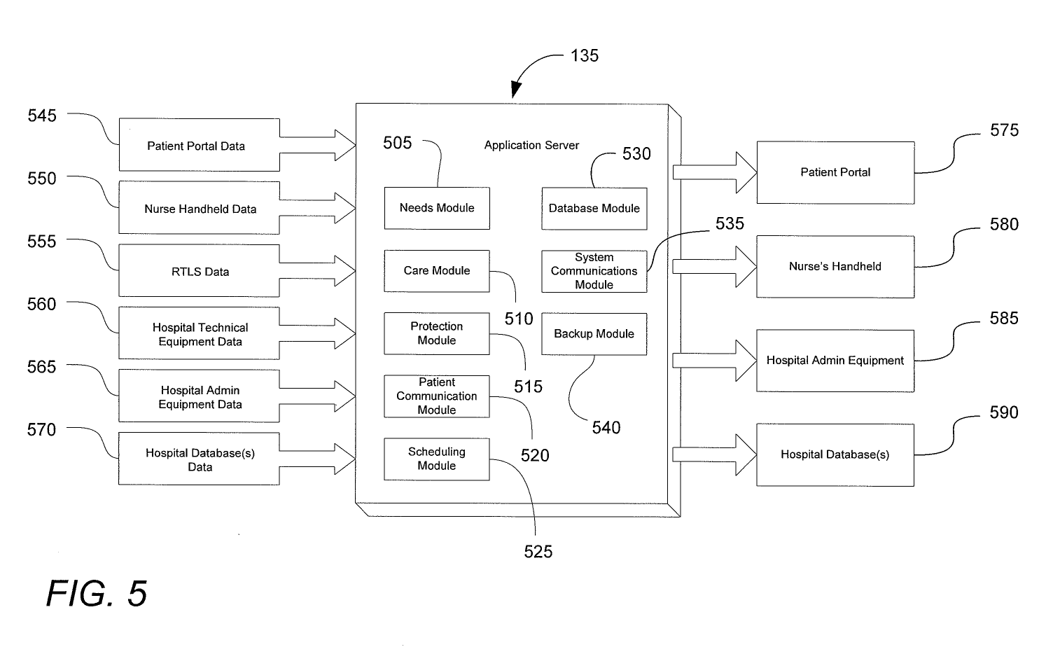

As shown in FIG. 1, the application server 135 comprises a computer designed to store applications or “modules;” to store data input and collected by the various elements of the patient-centric care management system 100; and to execute functions based on the data and modules. The application server 135 is in data communication with the communication server 140, and through that server, the other elements of the patient-centric care management system 100. Various modules stored on the application server 135 may be additionally installed on other elements of the patient-centric care management system 100, such as the handheld device 120 and the patient portal device 110. Further aspects of the application server 135 will be described below with reference to FIG. 5.

### Database Server

The database server 145 comprises a computer designed to execute applications that provide database services to other computer programs or computers it is connected to. The database server 145 may host databases such as, for example, a patient record database, an accounting database, a pharmacy database, a supply chain database, and others as necessary. In other embodiments, database server 145 may comprise a computer program running on a general purpose server. In the embodiment pictured in FIG. 1, the database server 145 is in data communication with the communication server 140, and provides database services to other elements of the patient-centric care management system 100.

### Hospital Technical Peripherals

The hospital technical peripherals 130, comprise network-connected hospital devices that are capable of providing data to the patient-centric care management system 100. Examples include smart intravenous (“IV”) infusion pumps, vital signs monitoring equipment, glucometers, and respiratory aids such as a ventilator. The hospital technical peripherals 130 are in data communications with the communication server 140, which provides access to other elements of the patient-centric care management system 100.

### Hospital Administrative Peripherals

The hospital administrative peripherals 150 include such things as pharmacy computers and ancillary administrative computers and systems, as well as locally attached devices including printers, scanners, barcode readers, local storage devices and other office equipment. In the embodiment pictured in FIG. 1, the hospital administrative peripherals 150 are in data communication with the communication server 140, which provides data access to the other elements of the patient-centric care management system 100.

### Remote Monitoring Device

The remote monitoring device 155 comprises one or more computers which provide patient status information to displays located away from the patients. The remote monitoring device 155 is in data communication with the communication server 140, which provides data access to other elements of the patient-centric care management system 100.

Thus, the above described elements comprise a preferred embodiment of the current invention. Principal advantages of this system include a high degree of data sharing between the interconnected elements, as well as a focus on empowering the patient to access and benefit from data relevant to his or her treatment in a hospital.

In FIG. 2, there is shown one embodiment of a patient portal device 110. The patient portal device 110 comprises a touch-screen display interface 205, a processor for running application modules (not pictured), Random Access Memory (RAM) (not pictured), Flash memory (not pictured), Read Only Memory (ROM) (not pictured), hardware to enable wired and wireless networking such as WiFi and Bluetooth (not pictured), hardware to enable reading RTLS tags (not pictured), a microphone 215 and speaker (not pictured) for enabling voice communications, a video-capable camera 220 for enabling video communication, a battery (not pictured) for enabling operation while not connected to a steady power source, a power port (not pictured) to receive standard outlet power, and a Universal Serial Bus (“USB”) (not pictured) for programming and other peripheral attachment. As shown in FIG. 2, the touch-screen interface 205 is displaying application module icons 210 that are configured to launch applications installed for use with the patient-centric care management system 100.

In FIG. 3, there is shown the same embodiment of the patient portal device 110 as described in FIG. 2, but with a different screen showing certain aspects of the patient-centric care management system 100. The patient portal device 110 is displaying application module icons 305 which allow the patient to access different application modules from the current screen. Also displayed on the patient portal device 110 is a message center 310 that allows the patient to send and receive a variety of message types, including but not limited to: emails messages, text messages, and other types of messages that are integrated with hospital systems and equipment. Also displayed on the patient portal device 110 is a schedule window 315 that shows the patient a schedule of events for the day, including meals, medical treatments, and doctors visits. One skilled in the art will appreciate that the scheduling feature can be configured to show many different types of information and many different time scales (i.e. day, week, month). Also displayed on the patient portal device 110 is an identification notification 320, which informs the patient of what hospital staff is currently in the room, and assigned to care for the patient. Again, this display is configurable to show different types of information. Finally, a time and date 325 are shown on the patient portal device 110.

In FIG. 4, there is shown one embodiment of the handheld device. The handheld device 120 comprises a touch-screen display interface 405, physical buttons 415 for interacting with the software, a processor for running application modules (not pictured), Random Access Memory (RAM) (not pictured), Flash memory (not pictured), Read Only Memory (ROM) (not pictured), hardware to enable wireless networking such as WiFi and Bluetooth (not pictured), hardware to enable reading RTLS tags (not pictured), a microphone 420 and speaker (not pictured) for enabling voice communications, a video-capable camera 425 for enabling video communication and barcode scanning, a battery (not pictured) for enabling operation while not connected to a steady power source, a power port (not pictured) to receive standard outlet power, and a Universal Serial Bus (“USB”) (not pictured) for programming and other peripheral attachment. Further, as shown in FIG. 4, the touch-screen interface 405 is displaying application module icons 410 that are configured to launch applications installed for use with the patient-centric care management system 100.

In FIG. 5, there is shown one embodiment of the functional data flows of the application server 135. Here the elements of the system that provide data to the application server 135 are shown as 545-570; the application modules which reside on the application server 135 and process or act on that data are shown as 505-540; and the elements of the system which receive data from the application server are shown as 575-590. The application modules 505-540 are configured to provide different services to the patient-centric care management system 100. For example, the needs module 505 provides communication with nurses, doctors, or other staff about patient needs; tracks response times to requests for reporting and efficiency planning; and reports patient satisfaction with service. The care module 510 provides access to vital signs and the patient's care and discharge plan; provides patient education; and measures patient experience and compliance. The protection module 515 provides system alarms and reminders configured to prevent medical errors; ensure blood transfusion safety; provide remote vital signs monitoring; monitors hand-washing and other cleanliness requirements; prevents falls, ulcers and surgical site errors; and provides for breast milk verification. The patient communication module 520 provides communication capabilities inside and outside of the hospital, and allows remote access to the needs module 505 and care module 510. The scheduling module 525 provides scheduling tools and other organizational tools for patients and hospital staff. The database module 530 provides interconnectivity between the application server 135 and application modules 505-540 for the purposes of data sharing, data storage, and data processing. Because the database module 530 is modular and software-based, it can be upgraded and augmented so as to provide wide compatibility with existing systems as well as future systems. The systems communication module 535 provides interconnectivity between the application server 135 and the patient portal 575, handheld device 580, hospital administrative equipment 585, and hospital databases 590 through the communication server (not shown). Because the system communication module 535 is modular and software-based, it can be upgraded and augmented so as to provide communication capabilities with existing systems that are not shown as well as future systems. The backup module 540 provides data backup and other archiving and storage services to the system. Also shown in FIG. 5 are various sources of data 545-570 used within the application server 135. Those skilled in the art will appreciate that the functional representation of the application server 135 represents only one embodiment, and many others that include different or additional data sources, application modules, or functional connections are possible.

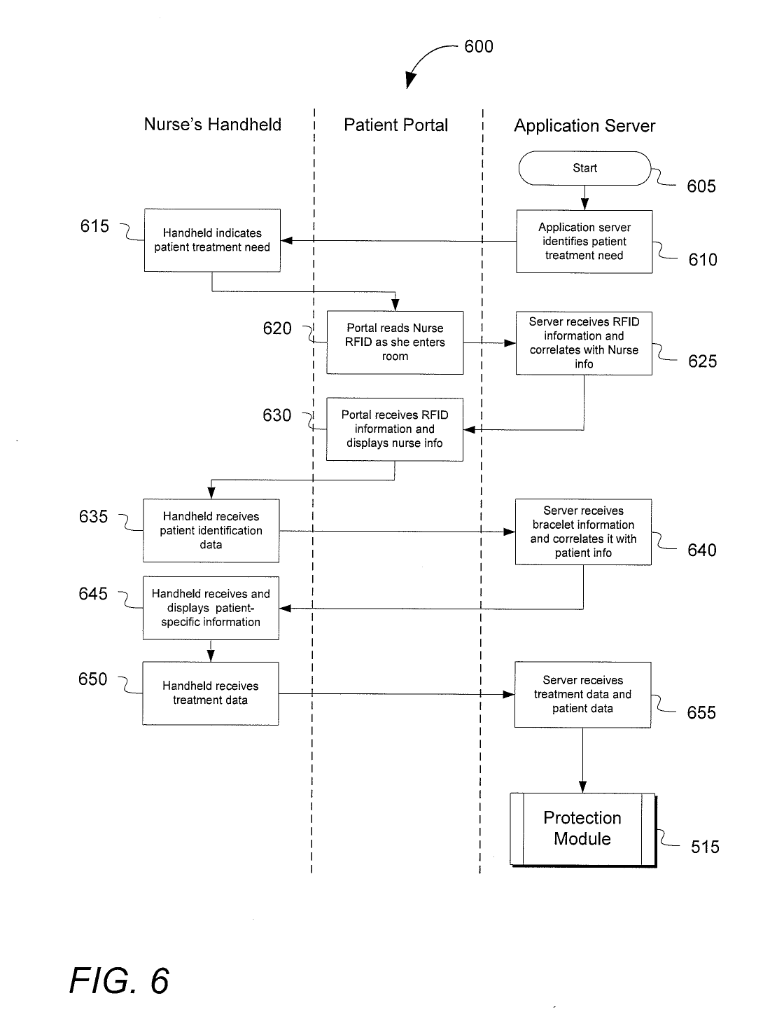

In FIG. 6, there is shown one method 600 for treating a patient using the patient-centric care management system 100. The three columns: “Nurse's Handheld,” “Patient Portal,” and “Application Server” represent tasks completed by those elements of the patient-centric care management system 100. The method 600 starts at ready state 605 then moves to a state 610 wherein the application server 135 identifies a patient's need for treatment. The application server 135 may identify this need in many ways, including scheduled treatments that the application server 135 is natively aware of, or treatment events driven by the patient through the patient portal device 110, or by a nurse identifying a need and registering it through the handheld device 120, or other ways. After identifying the need, the application server 135 pushes the information to a nurse's handheld device 120, which advances the method 600 to state 615. At state 615, the nurse's handheld device 120 indicates, for example, a patient treatment need, patient information, treatment information, scheduling information for that treatment, and other information as is necessary. After receiving this information, the nurse arrives in the patient's room which brings the method 600 to a state 620, wherein the nurse's presence in the patient's room is identified by the patient portal device 110 using, for example, RTLS technology, and data regarding the nurse's identity is sent back to the application server 135.

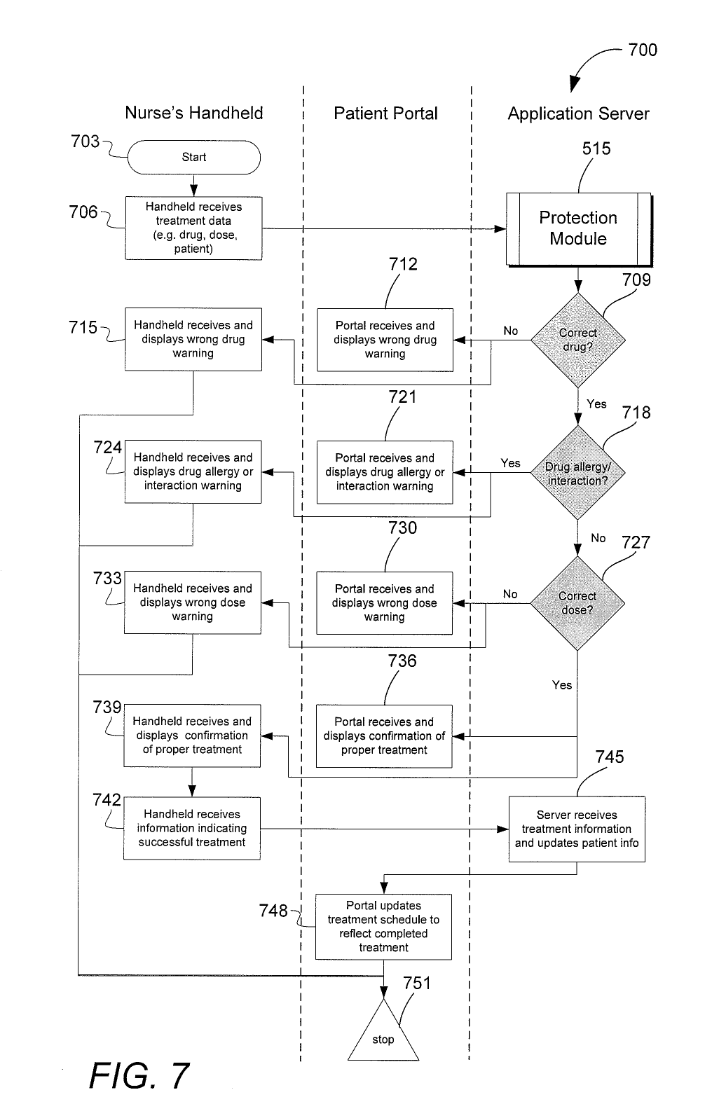

When the application server receives the information regarding the nurse's identity, the method 600 moves to state 625, wherein the application server 135 correlates nurse identification information with other relevant nurse information and pushes that information out to the patient portal device 110. When the patient portal device receives the applicable nurse information, the method 600 moves to state 630. In this state, the patient portal device 110 displays the nurse's information including, for example, his or her name, position, institutional affiliation, and other information as necessary. After the patient receives the information from the patient portal device 110, the nurse uses the handheld device 120 to receive patient identification data, bringing the method 600 to state 635. This step can be accomplished by, for example, scanning a barcode on the patient's wristband 125, or by receiving RTLS or other electronic information wirelessly from the patient's wristband. After the handheld receives the patient information, that data is sent back to the application server bringing method 600 to state 640. At state 640, the application server correlates the patient identification data with other relevant patient data stored on the server (or stored on other servers connected to the application server), such as: patient name, age, weight, drug allergies, recent treatments, scheduled treatments, and other information as necessary. After this step, the application server 135 sends the patient data back to the nurse's handheld device 120 bringing method 600 to state 645. At state 645, the nurse's handheld device 120 receives and displays patient-specific information which the nurse may use, for example, to tailor drug dosage for the patient. Next, the handheld device receives information regarding the treatment, which brings method 600 to state 650. At state 650, the treatment information, such as dosage of a particular drug, could be received by manual entry on the handheld device 120, barcode scan by the handheld device 120, or by other electronic means known now or later by those skilled in the art. Upon receiving this treatment data, the nurse's handheld device 120 sends that data and the patient data back to the application server, bringing method 600 to state 655. At state 655, the application server takes the treatment and patient data and invokes the protection module 515. The protection module process will be further described below in FIG. 7. In another embodiment, the nurse's handheld device 120 may send treatment data directly to the patient portal device 110, which may then display the treatment data for the patient before the protection module 515, described below in FIG. 7 is invoked.

In FIG. 7, there is shown one method 700 for protecting a patient using a protection module 515 within an application server 135. The method 700 starts at a ready state 703. When a nurse's handheld device receives treatment data such as a drug, a dose, and patient-specific information, the method 700 moves to a state 706, wherein the nurse's handheld device pushes the data to the application server, which invokes the protection module 515. The protection module 515 then runs through a set of decision states, starting with decision state 709, wherein the protection module takes the treatment data, and specifically the drug data, and decides whether it is the correct drug for the patient.

If at decision state 709 the protection module 515 identifies an error with the drug type, it sends warnings to the patient portal 110 and the nurse's handheld device 120. After receiving warning data, the patient portal displays the warning data to the patient bringing the method 700 to state 712. Concurrently, the nurse's handheld device 120 receives and displays warning data bringing the method 700 to state 715. Notably, here nothing is implied by the ordering of the warning states; that is: the representation that the portal receives the warning first is not a necessary aspect of the system. After warnings are displayed in states 712 and 715, the method 700 moves to a stopped state 751.

If at decision state 709, the protection module 515 identifies the drug as the correct drug, then the method 700 moves to state 718, wherein the patient data is then checked for indications of a drug allergy or an interaction with any other treatments known to have been administered or that are scheduled to be administered.

If at decision state 718 the protection module 515 identifies a potential or known drug allergy or interaction, it sends warnings to the patient portal 110 and the nurse's handheld device 120. After receiving warning data, the patient portal displays the warning data to the patient brining the method 700 to state 721. Concurrently, the nurse's handheld device 120 receives and displays warning data brining the method 700 to state 724. After warnings are displayed in states 721 and 724, the method 700 moves to a stopped state 751.

If at decision state 718, the protection module 515 does not identify a potential or known allergy or interaction, method 700 moves to decision state 727, wherein the drug is then checked correct dosage.

If at decision state 727, the protection module 515 identifies an error with the drug dose, it sends warnings to the patient portal 110 and the nurse's handheld device 120. After receiving warning data, the patient portal displays the warning data to the patient bringing the method 700 to state 730. Concurrently, the nurse's handheld device 120 receives and displays warning data bringing the method 700 to state 733. After warnings are displayed at states 730 and 733, the method 700 moves to a stopped state 751.

If at decision state 727, the protection module 515 identifies the dosage as correct, then the method 700 moves to state 736, wherein the patient portal device 110 receives and displays confirmation that the treatment is proper. At the same time, the nurse's handheld device 120 receives and displays confirmation of the proper treatment, bringing the method 700 to state 739.

After treatment, the nurse's handheld 120 receives information indicating that the treatment has been successfully administered, bringing method 700 to state 742. At state 742, the nurse's handheld pushes the successful treatment data to the application server 135, bringing the method 700 to state 745. At state 745, the application server 135 receives the treatment information and updates various databases such as, for example, a patient database, an accounting database, a pharmacy database, and others as necessary. Next, the application server 135 pushes the updated data out to the patient portal device 110 to reflect the completed treatment and updates the patient's schedule accordingly, bringing the method 700 to 748. Finally, the method 700 ends at state 751. In another embodiment, the protection module 515 runs natively on the patient portal device 110 while still in data communications with other elements of the patient-centric care management system 100.

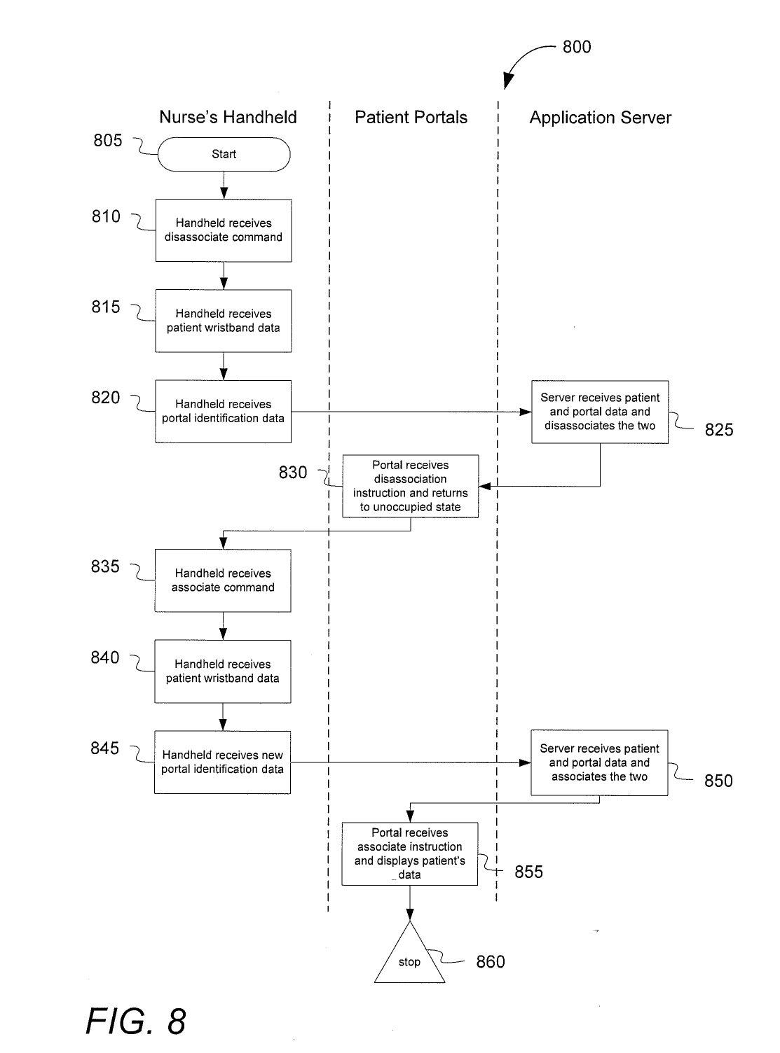

In FIG. 8, there is shown one method 800 for disassociating and associating patient portal devices with a patient who is moved between different rooms in a hospital, such as, for example, between a patient room and a surgery ward. The method 800 starts at a ready state 805, wherein a first patient portal device is associated with a patient. The method 800 moves to state 810 when a nurse's handheld device receives a disassociate command. In some embodiments, this command is initiated by the nurse on the nurse's handheld device. Next, the method 800 moves to a state 815 when the nurse's handheld device 120 receives the patient's wristband 125 data. As described above, this step can be accomplished by, for example, the nurse scanning a barcode on the patient's wristband 125 with the nurse's handheld, or by the nurse's handheld receiving RTLS or other wireless electronic information from the patient's wristband. Next, the method 800 moves to a state 820 when the nurse's handheld device 120 receives portal identification data. Like the wristband, this step can be accomplished by, for example, using the nurse's handheld to scan a barcode on the patient portal, or by receiving RTLS or other wireless electronic information from the patient portal. When the nurse's handheld has received both patient wristband 125 and patient portal identification data, the data is sent to the application server 135. At state 825, the application server 135 receives the patient wristband 125 data, the patient portal identification data, and the disassociate command, and disassociates the patient portal from the patient. The application server 135 then sends a command to the first patient portal to disassociate with the patient, moving the method 800 to state 830. At state 830 the portal receives the disassociate command and returns to a home screen with no patient-specific data. The method 800 then moves to state 835 where the nurse's handheld 120 receives an associate command. In some embodiments, this command is initiated by the nurse on the nurse's handheld device. Next the nurse's handheld receives patient wristband 125 data and moves to state 840, then receives identification data for a second patient portal device moving method 800 to state 845. At state 845, the nurse's handheld device 120 sends the patient's wristband 125 data and the second patient portal identification data to the application server 135, moving method 800 to state 850. At state 850, the application server 135 receives the patient wristband 125 data and the second patient portal identification data along with the associate command, and associates the second patient portal with the patient. The application server 135 then sends a command to the second patient portal 110 to associate with the patient and passes to the portal patient specific information stored on the server, such as, e.g., the patient's name, schedule, messages, and other application specific data. Once the second patient portal has successfully associated with the patient, the method 800 moves to a stopped state 860.

The foregoing presentation of the described configurations is provided to enable any person skilled in the art to make or use the methods and other structures disclosed herein. Various modifications to these configurations are possible, and the generic principles presented herein may be applied to other configurations as well. As may be appreciated from the context, for example, a configuration may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit. The data storage medium may be an array of storage elements such as semiconductor memory (which may include without limitation dynamic or static RAM (random-access memory), ROM (read-only memory), and/or flash RAM), or ferroelectric, magnetoresistive, ovonic, polymeric, or phase-change memory; or a disk medium such as a magnetic or optical disk. The term “software” should be understood to include source code, assembly language code, machine code, binary code, firmware, macrocode, microcode, any one or more sets or sequences of instructions executable by an array of logic elements, and any combination of such examples.

Each of the methods disclosed herein may also be tangibly embodied (for example, in one or more data storage media as listed above) as one or more sets of instructions readable and/or executable by a machine including an array of logic elements (e.g., a processor, microprocessor, microcontroller, or other finite state machine). Thus, the present disclosure is not intended to be limited to the configurations shown above but rather is to be accorded the widest scope consistent with the principles and novel features disclosed in any fashion herein, including in the attached claims as filed, which form a part of the original disclosure.

What is claimed is:

1. A system for managing medical care, comprising:
a patient identifier configured to be worn by a patient and comprising an identification code that uniquely identifies the patient;
a handheld device configured to read the identification code from the patient identifier; and
a patient portal device, comprising a display and in communication with the patient identifier and the handheld device.

2. The system of claim 1, wherein the handheld device is configured to read the patient identifier using a wireless technology.

3. The system of claim 1, further comprising a server configured to store patient data and transmit that patient data to the handheld device and the patient portal device.

4. The system of claim 1, wherein the patient portal device is configured to display warnings to the patient in response to a medication error.

5. The system of claim 1, wherein the patient portal device is configured to display a schedule of patient activities to the patient.

6. The system of claim 1, wherein the patient portal device is configured to allow the patient to send emails or text messages.

7. The system of claim 1, wherein the patient identifier is a wristband.

8. The system of claim 7, wherein the identification code is stored in a memory in the wristband.

9. The system of claim 7, wherein the identification code is a bar code printed on the wristband.

10. The system of claim 1, wherein the handheld device is configured to communicate with the patient portal device and to send the patient portal device medication decisions that are input on the handheld device.

11. The system of claim 1, wherein the patient portal device comprises a touch-screen interface.

12. The system of claim 1, wherein the patient portal device comprises instructions for displaying a warning to the patient if a medication error is detected.

13. An electronic system for displaying patient data to a patient in a hospital, comprising:
a server comprising a storage that stores patient records and a first module configured to provide a schedule of patient activities;
a patient portal device configured to communicate with the server and display the schedule of patient activities to the patient; and
a scheduling module running on the patient portal device and configured to update the schedule of patient activities.

14. A system for protecting a patient from medical errors, comprising:
a server configured to store patient medical records;
a patient portal device in communication with the server and configured to electronically monitor the patient medical records for indicators of medical errors; and
a protection module configured to generate a patient-specific alert on the patient portal device if a medical error is detected.

15. The system of claim 14, wherein the alert is a text-based alert warning of a medication error.

16. The system of claim 14, wherein the alert is an audio alert warning of a medication error.

17. The system of claim 14, wherein the alert is a text-based alert warning of a pending procedure error.

18. The system of claim 1, wherein the patient portal device displays a name of a caregiver who is responsible for the patient's care.

19. The system of claim 18, wherein the patient portal device displays a title for the caregiver.

20. The system of claim 18, wherein the patient portal device displays a picture of the caregiver.

21. The system of claim 1, wherein the patient portal device displays a patient treatment goal to be completed within a period of time.
